(19) United States
(12) Patent Application Publication
(10) Pub. No.: US 2013/0283863 A1
(43) Pub. Date: Oct. 31, 2013

(54) METHOD OF FUSING AND STRETCHING A LARGE DIAMETER OPTICAL WAVEGUIDE

(71) Applicant: WEATHERFORD/LAMB, INC., Houston, TX (US)

(72) Inventors: Edward Michael Dowd, Madison, CT (US); Andy Kuczma, III, Clinton, CT (US); Brian John Pike, Wallingford, CT (US)

(21) Appl. No.: 13/929,430

(22) Filed: Jun. 27, 2013

Related U.S. Application Data
(63) Continuation of application No. 10/751,666, filed on Jan. 5, 2004, now abandoned.
(60) Provisional application No. 60/438,165, filed on Jan. 6, 2003.

(51) Int. Cl. C03B 37/027

(52) U.S. Cl. CPC C03B 37/027
USPC 65/412

(57) ABSTRACT

Methods for making a preform for a large diameter optical waveguide such as a cane waveguide are disclosed. The method includes inserting a preform into a glass tube to serve as cladding that provides a thickened preform, simultaneously fusing and stretching the thickened preform, sectioning the stretched and still thickened preform and repeating the procedure if necessary to provide an even further thickened preform. The drawing apparatus can be configured to work with the preform disposed either horizontally or vertically and usually includes a graphite resistance furnace. Typically, the drawing apparatus is an upper portion of a draw tower used for drawing an optical fiber from an optical fiber preform. The draw tower includes a tractor pulling mechanism that can adjust to grip a wide range of diameters.

### CROSS-REFERENCE TO RELATED APPLICATIONS

This application is a continuation of U.S. patent application Ser. No. 10/751,666, filed Jan. 5, 2004, which claims benefit of U.S. Provisional Patent Application Ser. No. 60/438,165, filed Jan. 6, 2003, both of which are herein incorporated by reference in their entireties.

### BACKGROUND OF THE INVENTION

1. Field of the Invention

The invention generally relates to fabricating a large diameter optical waveguide preform. More particularly, the invention relates to overcladding a preform for use in making a large diameter optical waveguide such as a cane waveguide.

2. Description of the Related Art

An optical fiber is generally fusion drawn from a fiber preform by one of several processes. The fiber preform is essentially an undrawn optical fiber that is an enlarged embryonic version of the optical fiber. The fiber preform includes a core and a cladding in the same ratio as desired for the optical fiber that is to be fusion drawn from the fiber preform. In one example, a 1 meter long fiber preform with an outer diameter of 3 centimeters can be fusion drawn to produce an approximately 90 kilometer long optical fiber with an outer diameter of 125 microns.

Preforms are traditionally manufactured by chemical vapor deposition (CVD), which may include modified chemical vapor deposition (MCVD), plasma modified chemical vapor deposition (PMCVD or PCVD), outside vapor deposition (OVD), and vapor axial deposition (VAD). In MCVD, glass forming oxides deposit on the inside of a silica tube using a heat source such as an oxygen/hydrogen (O₂/H₂) torch or a plasma torch to drive the oxidation reaction. In OVD and VAD, glass forming oxides deposit on a target mandrel and far greater deposition rates can be achieved. The low deposition rates in MCVD are offset by the ability to fabricate complex waveguide profiles. The preform resulting from one of the CVD processes before adding additional layers of cladding is called a seed preform.

As a consequence of the low deposition rates and process set up times, preforms made by MCVD often require additional silica layers added to the outside of the seed preform to achieve the desired doped glass core to outside diameter ratio. Often, the additional layers are added to the seed preform by inserting the seed preform into a silica sleeve or tube and fusing the sleeved seed preform on the same lathe with the same or a similar O₂/H₂ torch as used during the deposition of the seed preform. Alternatively, U.S. Pat. No. 5,578,106 discloses replacing the O₂/H₂ torch with a plasma torch for the heat source. Additionally, U.S. Pat. Nos. 4,820,322 and 6,053,013 disclose inserting a preform into a sleeve or tube of cladding material and fusing this one additional layer on a fiber optic draw tower in order to permit fusing while simultaneously stretching the fiber and fused material to a desired final diameter. U.S. Pat. Nos. 5,578,106, 4,820,322 and 6,053,013 are all hereby incorporated by reference. However, all of the methods disclosed in these patents are methods for sleeving and fusing seed preforms during the drawing of an optical fiber. The fiber preform that is created and used to draw the optical fiber in the prior art has undergone at most a single sleeve and fusing operation. However, the production of the optical fiber may require multiple sleeving and stretching steps prior to the final draw of the optical fiber.

Large diameter optical waveguides called cane waveguides, such as described in U.S. patent application Ser. No. 09/455,868, filed Dec. 6, 1999, and hereby incorporated by reference, are rigid structures unlike optical fibers and have a core similar in size to that of a conventional optical fiber. However, the cane waveguides have a much larger cladding than the optical fiber. Thus, a cane preform requires substantially more cladding relative to the core than the fiber preform for the optical fiber. The core in a cane waveguide for a single mode of transmission is approximately 4 to 9 microns in diameter while the core for multi-mode transmission is approximately 50 to 60 microns in diameter. Unlike the 125 micron outer diameter of the optical fiber, the outer diameter of the cane waveguide is approximately 1 to 10 mm for either single mode or multi-mode transmission. Additionally, a cane preform has an outer diameter in the range of from approximately 5 to 100 mm.

Fabricating the cane preform requires fusing multiple sleeves to the seed preform since a single sleeve and fusing operation as used in the preparation of a fiber preform fails to provide a sufficient thickness of cladding needed for a cane preform when starting with the seed preform. However, the prior art does not address the problem of how to perform multiple fusing operations to add multiple sleeves. For example, U.S. Pat. Nos. 4,820,322 and 6,053,013 provide for a single fusing operation to produce a fiber preform from a seed preform from which an optical fiber is drawn. Performing a series of fusing operations to add multiple sleeves by using a lathe and the same or similar O₂/H₂ torch as used in fabricating the seed preform by CVD decreases product yield since this process is slow.

Therefore, there exists a need for methods to more rapidly perform multiple sleeving and fusing operations necessary during the production of optical waveguides.

### SUMMARY OF THE INVENTION

The invention generally relates to methods for making a preform for a large diameter optical waveguide such as a cane waveguide. The method includes inserting a preform into a glass tube to serve as cladding that provides a thickened preform, simultaneously fusing and stretching the thickened preform, sectioning the stretched and thickened preform and repeating the procedure as necessary to provide an even further thickened preform. The drawing apparatus can be configured to work with the preform disposed either horizontally or vertically and usually includes a graphite resistance furnace. Typically, the drawing apparatus is an upper portion of a draw tower used for drawing an optical fiber from an optical fiber preform. The draw tower includes a tractor pulling mechanism that can adjust to grip a wide range of diameters.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a view illustrating the operation of making a cane preform using a draw tower.

FIG. 2 is a top cross sectional view of a seed preform inside a sleeve.

FIG. 3 is a sectional view of the seed preform inside the sleeve that is taken across Line 3-3 of FIG. 2.

FIG. 4 is a flowchart illustrating a method for making the cane preform.

### DETAILED DESCRIPTION OF THE PREFERRED EMBODIMENT

The invention provides a method for fabricating a large diameter optical waveguide such as a cane waveguide, which can be fabricated from a cane preform. The large diameter waveguide is photosensitive and guides propagating light, e.g., a germania-doped silica core fiber having an outer cladding diameter of approximately 1-10 millimeters and a core outer diameter of about 4-60 micrometers depending on whether the waveguide is single mode or multi-mode. As such, the large diameter waveguide has a larger cladding to core ratio than an optical fiber that typically has an outer cladding diameter of approximately 125 micrometers and a core diameter of approximately 9 micrometers. The optical waveguide may be made from other materials or glasses, e.g., silica, phosphate glass, glass and plastic, or solely plastic. Also, a multi-mode, birefringent, polarization maintaining, polarizing, multi-core, flat or planar (where the waveguide is rectangular shaped), or other optical waveguide may be used if desired.

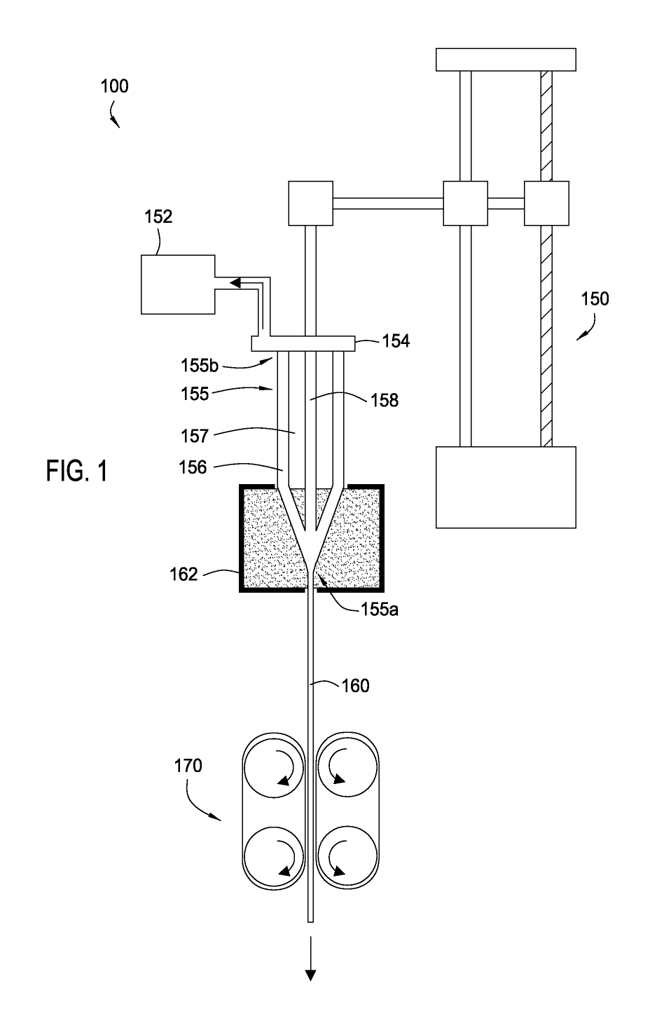

FIG. 1 illustrates a drawing apparatus 100 in use during one of a series of steps for simultaneously fusing and stretching a preform such as a seed preform 158 in the first stage and then a cane preform in later stages. Use of the drawing apparatus 100 does not require a separate overcladding process such as a fusing operation separate and distinct from stretching or drawing a sleeved and fused assembly. The drawing apparatus 100 may be the upper portion of a draw tower used for drawing an optical fiber from an optical fiber preform that has been modified to include a tractor pulling mechanism 170 able to grip a wide range of diameters. The tractor pulling mechanism 170 adjusts to grip lengths of preform having various thicknesses that range from the size of a leading strand from the seed preform which is typically on the order of a few hundred microns in diameter to the size of the cane preform which is typically from 2 to 10 mm in diameter. The drawing apparatus 100 may also be as shown but configured to draw a preform 158 disposed such that the long axis of the preform 158 is horizontal.

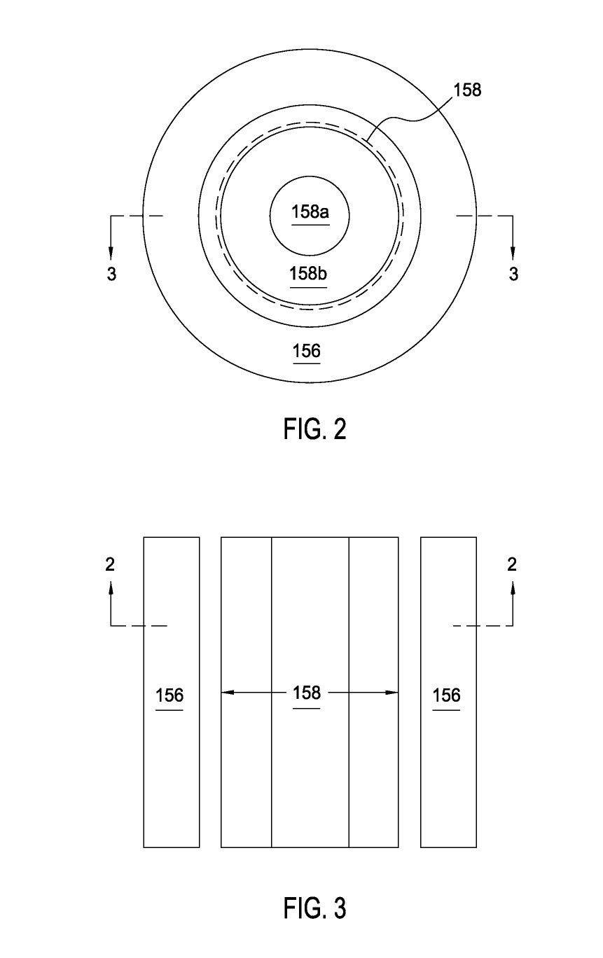

Referring now also to FIGS. 2 and 3, a seed preform 158 having a core 158a and a first layer of cladding 158b is inserted into a glass tube 156 during use of the drawing apparatus 100. In this manner, the seed preform 158 is sleeved to provide a preform/tube assembly 155. Preparatory to fusing and stretching the preform/tube assembly 155 with the drawing apparatus 100, one end 155a of the preform/tube assembly 155 is sealed together leaving the other end 155b unsealed. Alternatively, one end of the tube 156 can be sealed without necessarily fusing to the seed preform 158 (i.e. the bottom of the tube 156 is sealed with the seed preform 158 suspended above the sealed portion of the tube 156). The unsealed end 155b clamps in a chuck 154 connected to a vacuum pump 152 and provided with a feed module 150 of the drawing apparatus 100. Throughout the operation of the drawing apparatus 100, the vacuum pump 152 removes air from the annular gap 157 between the preform 158 and the glass tube 156. The vacuum pump 152 maintains a vacuum of approximately −700 mm of mercury in the gap 157.

The sealed end 155a feeds into a graphite resistance furnace 162 and aligns with a hot zone of the furnace 162. The graphite resistance furnace 162 includes a tubular structure having sides made of graphite through which direct current flows and causes heat via Joulean heating. Other types of furnaces or heat sources such as an induction heater or an open flame may be used instead of the graphite resistance furnace 162. However, the graphite resistance furnace 162 is preferable since the furnace 162 provides good control of the heat zone in both spatial extent and in temperature and is able to turn on and off as needed. In operation, argon (Ar) gas or some other inert gas or combination of inert gases is injected at about 10 liters per minute (LPM) into the bore of the graphite resistance furnace 162 to prevent oxidation of the graphite. The sealed end 155a of the preform/tube assembly 155 may be preheated by the furnace 162 for approximately twenty minutes, depending on the operating parameters. Further heating softens the preform/tube assembly 155 until a leading strand (not shown) from the sealed end 155a drops down if the long axis of the preform 158 is oriented vertically in the drawing apparatus 100 or is pulled if the preform 158 is oriented horizontally.

The tractor pulling mechanism 170 grips the leading strand when the strand drops down to the tractor pulling mechanism 170. The tractor pulling mechanism 170 may be disposed downstream of the graphite resistance furnace 162 and close enough to the furnace that the tractor pulling mechanism 170 grips the stretched and thickened preform 160 being extruded from the furnace instead of the leading strand. When the stretched and thickened preform 160 is completely extruded from the furnace 162, the leading strand is cut off and discarded. Once in the grip of the tractor pulling mechanism 170, the strand is pulled at the same time as the preform 158 feeds into the graphite resistance furnace 162 by the feed module 150. In this manner, a stretched preform 160 extrudes from or is drawn from the furnace 162. The glass tube 156 fuses to the preform 158 as the preform/tube assembly 155 passes through the furnace 162. The stretched preform 160 has a predetermined thickness and a predetermined cladding to core ratio. However, the stretched preform 160 is an intermediate stage cane preform that may be too thin and lacks the proper cladding to core ratio to be used for a cane preform.

The intermediate stage cane preform may be sectioned (e.g. cut into three sections) and each section inserted into a second glass tube to provide a thicker preform/tube assembly that is mounted in the drawing apparatus 100 in the same manner as the preform/tube assembly 155 having the seed preform 158 therein. Sectioning the intermediate stage cane preform provides for manageable lengths of the intermediate stage cane preform. The process for using the drawing apparatus 100 as described above is repeated to provide subsequent intermediate stage cane preforms, and, eventually the final cane preform or the final cane waveguide. The actual outer diameter of the thicker preform/tube assembly may not be larger than the preform/tube assembly 155 having the seed preform 158 therein so long as the proper cladding to core ratio is achieved with the proper outer diameter of the final cane preform or the final cane waveguide. Thus, the thicker preform/tube assembly merely refers to a larger cladding to core ratio than the preform/tube assembly 155 having the seed preform 158 therein. The tractor pulling mechanism 170 may be adjusted between each subsequent sleeving, fusing, and stretching to accommodate any increases in the outer diameters of respective products, i.e. subsequent intermediate stage cane preforms or the final cane preform. The entire process as described is typically repeated two times to make the final cane preform and three times to make the final cane waveguide.

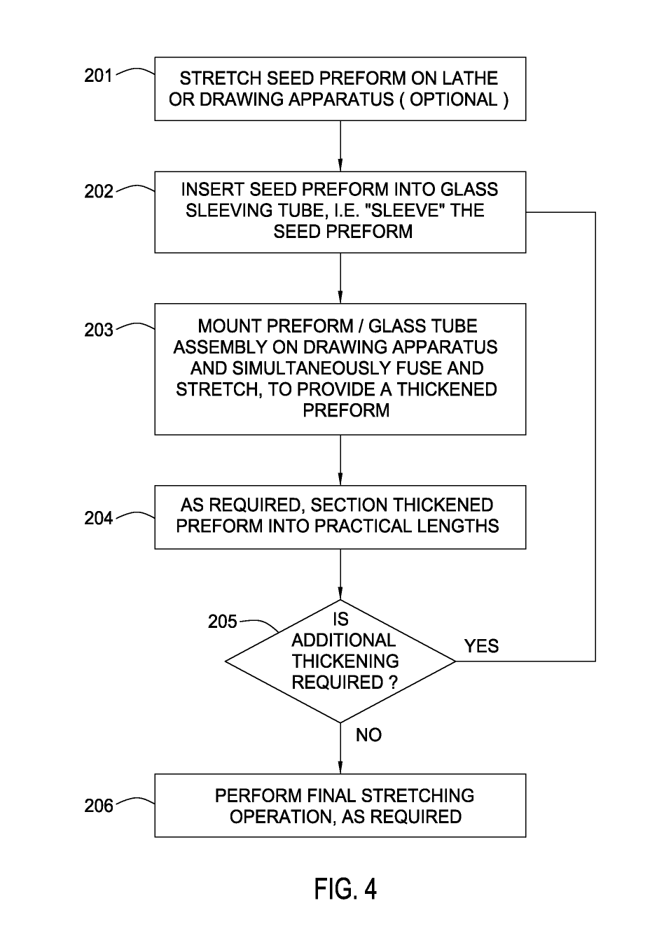

FIG. 4 shows a flowchart summarizing a particular method for fabricating the cane preform or the cane waveguide using the drawing apparatus 100 as described in detail above and shown in FIG. 1. The flowchart includes a first step 201 in which a seed cane preform having a core sized to end with a final diameter appropriate for single-mode or multi-mode transmission and an outer diameter of approximately 5 mm is optionally stretched on a lathe or drawing apparatus to arrive at a desired starting cladding to core ratio and provide a small enough outer diameter to fit inside a glass tube. For this particular embodiment, the glass tube has an inner diameter of approximately 10 mm and an outer diameter of approximately 30 mm. In a next step 202, the seed cane preform is placed into the glass tube such that the seed cane preform is sleeved. In a further step 203, the combined preform/tube assembly is simultaneously fused and stretched using the drawing apparatus to provide a thickened preform (e.g. an intermediate stage cane preform). As described above, the thickened preform has a larger cladding to core ratio but may not have a greater overall diameter due to the stretching. The thickened preform is then sectioned into practical lengths in a step 204.

As indicated at step 205, steps 202 through 204 are repeated until a desired final cane preform with an outer diameter of approximately 5 mm and a desired cladding to core ratio is achieved. In a final step 206, the cane preform may be further drawn on the drawing apparatus using a precision tractor pulling mechanism if the cane preform does not already have the desired final cladding to core ratio. Thus, at least two sleeves are used and at least two simultaneous fusing and stretching operations are performed in producing the cane preform from the seed cane preform. To produce a cane waveguide from the cane preform, an additional sleeving operation followed by a simultaneous fusing and stretching operation is performed.

The stretching shown in the steps 201, 203 or 206 may alternatively be used to pre-draw a finished preform to a smaller diameter prior to a final draw. Some fiber coating processes used to apply coatings such as polyimide or carbon require slow draw speeds to deposit the desired thickness. The slow draw speed coupled with a high preform to fiber or waveguide size ratio results in poor control of the diameter of the fiber or waveguide. Further, slow draw speeds are difficult to achieve with large diameter preforms (e.g. larger than 30 mm) because of instabilities of the draw furnace thermal gradient and the feed module. Thus, the stretching operation in the steps 201, 203 or 206 allows coating processes completed later to be performed slowly since the preform may be substantially pre-drawn during the steps 201, 203 or 206.

Embodiments of the invention provide many advantages when compared to traditional methods that do not provide multiple simultaneous fusing and stretching of preforms. One advantage is that a small inner diameter draw furnace can be used to provide high yields of waveguide per seed preform. A seed preform may require an overclad of 200 mm in diameter or greater in order to have a cladding to core ratio needed for a waveguide with single mode operation. Thus, the preform/tube assembly used in a single sleeving and fusing operation requires such a large sleeve tube that a larger inner diameter draw furnace than is commercially available today is required. The multiple simultaneous fusing and stretching process reduces the size of the preform/tube assemblies since each fusing and stretching operation changes the cladding to core ratio without necessarily increasing the overall outer diameter.

Another advantage is that larger core diameters can be deposited in the seed preform due to the multiple stretchings that achieve the proper cladding to core ratio. Typically, an MCVD process results in a core varying along the length of the seed preform. However, multiple core deposition passes effectively average the variations from each deposition layer along the core in order to minimize the overall variability. The ability to use larger core diameters permits the multiple core deposition passes.

Still another advantage is that precise sizing of cladding to core ratio is possible, which reduces variability in the cladding to core ratio and reduces the raw material inventory. Since the seed preform is optionally stretched or drawn prior to sleeving, the seed preform core diameter can be predetermined to mate with a fixed sleeve tube cross sectional area. In other words, variability in cladding to core ratio among different seed preforms can be adjusted during the seed preform stretch phase to yield a precise cladding to core ratio when sleeved and fused with a given tube during final or intermediate draws. This allows for tighter core diameter, second mode cutoff and mode field diameter tolerances in the cane preform or cane waveguide. The less forgiving prior art single sleeving and fusing operation followed by a stretching operation requires very tight seed preform manufacture process control and/or multiple sleeve tube CSA availability. Even with lathe preform stretching techniques, the seed preform cannot be stretched uniformly because of extra variables such as flame uniformity, preform sagging on horizontal lathes, and glass burn off from flame heating.

Yet another advantage is reduced final waveguide hydroxyl ion (OH) concentration when compared to that resulting from sleeving and O₂/H₂ torch stretching. Traditional lathe sleeving and fusing techniques that collapse a sleeve tube over a seed preform can lead to migration of OH and hydrogen (H₂) in the core and inner cladding of the preform and the subsequently drawn cane preform or cane waveguide. The OH and H₂ contamination results in significant optical attenuation, particularly in the 1350 nm to 1450 nm wavelength range.

Yet even another advantage is the higher final waveguide yield compared to torch driven fusing and stretching. The invention reduces burn off and tip-off loss, i.e. loss of material at the tip of the preform during the overcladding process because the material is of the wrong diameter. Preform sleeving and fusing using a gas burner as the heat source results in removal of 20% to 25% of the silica material due to the intense heat and reducing atmosphere. However, adjusting gas flows of the burner to reduce burn off results in a cooler flame that greatly increases process time and may make sleeving impossible. The sleeving and then simultaneous fusing and stretching with the draw tower and furnace in accordance with embodiments of the invention results in little or no burn off because the process takes place in an inert atmosphere.

Still yet even another advantage is increased throughput. To sleeve and fuse a preform and then stretch it on a lathe takes about two to three hours. However, the sleeving and then simultaneous fusing and stretching process when performed on the draw tower according to the invention requires less than one hour.

Even yet another advantage is the uniform outer diameter provided by the invention using the drawing apparatus. Preforms stretched on a lathe using a gas burner result in diameter variations on the order of 100 microns. The graphite resistance furnace provides better temperature control compared to an O₂/H₂ gas burner as typically used with the lathe. The superior temperature control results in a uniform melt and stretch that provides a final outer diameter that varies on the order of only 10 microns or less.

Yet another advantage is that the invention allows continuous preform stretch for large glass lot sizes. Preforms stretched using a lathe are limited in final length by the size of the lathe bed. If longer stretching is required, the process must be stopped to section cut the stretched preform and axially reposition the lathe chucks. With the invention, the tractor pulling mechanism pulls the stretched preform continuously such that the preform can be sectioned at any point after the tractor pulling mechanism or left in one piece.

It is to be understood that the above described arrangements are only illustrative of the application of the principles of the invention. In particular, it should be understood that although the invention has been shown and described for making a cane preform, the invention may be used in making a preform for any optical waveguide in which the cladding is substantially greater in thickness than for an optical fiber. In this manner, multiple sleeving and then simultaneous fusing and stretching operations would be either required or advantageous. More generally, the invention may be used to advantage when producing any type of optical waveguide or optical fiber prior to the final draw.

While the foregoing is directed to embodiments of the present invention, other and further embodiments of the invention may be devised without departing from the basic scope thereof, and the scope thereof is determined by the claims that follow.

1. A method for making, in a drawing apparatus, an optical cane waveguide having a predetermined cladding to core ratio, comprising:
placing a seed preform into a first sleeving tube to provide a first sleeved preform;
fusing and stretching the first sleeved preform in the drawing apparatus to provide a first stretched preform;
placing at least a portion of the first stretched preform into a second sleeving tube to provide a second sleeved preform, wherein at least one of the first or second sleeving tube comprises silica;
fusing and stretching the second sleeved preform to provide a second stretched preform in the drawing apparatus; and
stretching the second stretched preform to produce the cane waveguide having an outer diameter of at least 1 millimeter.

2. The method of claim 1, wherein the fusing and stretching are performed substantially simultaneously in the drawing apparatus.

3. The method of claim 1, further comprising sectioning the first stretched preform to provide a plurality of sections of stretched preform.

4. The method of claim 1, wherein the fusing and stretching of the first sleeved preform is performed as successive portions of the first sleeved preform are pulled into a heating zone of a furnace by a pulling mechanism.

5. The method of claim 1, wherein the fusing and stretching of the first sleeved preform is performed on the drawing apparatus comprising a heat source.

6. The method of claim 5, wherein the heat source comprises at least one of a graphite resistance furnace, an induction heater, or a flame.

7. The method of claim 5, wherein the first sleeved preform has a longitudinal axis and wherein the drawing apparatus is configured so that the longitudinal axis of the first sleeved preform preform is disposed vertically.

8. The method of claim 5, wherein the first sleeved preform has a longitudinal axis and wherein the drawing apparatus is configured so that the longitudinal axis of the first sleeved preform is disposed horizontally.

9. The method of claim 1, further comprising stretching the seed preform.

10. The method of claim 1, wherein the stretching of the second sleeved preform involves a banded tractor pulling mechanism adapted to grip the second stretched preform having a diameter between 2 mm and 10 mm.

11. The method of claim 10, wherein the pulling mechanism is adjusted between the fusing and sleeving of the first sleeved preform and the fusing and sleeving of the second sleeved preform.

12. A method of producing an optical cane waveguide having a cladding, comprising:
sleeving, fusing, and stretching a preform, wherein at least the fusing and stretching are performed in a drawing apparatus; and
repeating the sleeving, fusing and stretching as necessary to obtain the cane waveguide having a desired cladding-to-core ratio and an outer diameter of at least 1 mm, wherein at least the repeated fusing and stretching are performed in the same drawing apparatus and wherein the cladding comprises silica.

13. The method of claim 12, wherein a core diameter of the cane waveguide is between 4 and 60 micrometers and wherein an outer diameter of the cane waveguide is greater than 1 millimeter.

14. The method of claim 12, wherein the fusing and stretching are performed substantially simultaneously in the drawing apparatus.

15. The method of claim 12, wherein all the fusing and stretching are performed on one drawing apparatus, the drawing apparatus comprising a heat source.

16. The method of claim 15, wherein the heat source comprises at least one of a graphite resistance furnace, an induction heater, or a flame.

17. The method of claim 15, wherein the preform has a longitudinal axis and wherein the drawing apparatus is configured so that the longitudinal axis of the preform is disposed vertically.

18. The method of claim 15, wherein the preform has a longitudinal axis and wherein the drawing apparatus is configured so that the longitudinal axis of the preform is disposed horizontally.

19. The method of claim 12, further comprising sectioning the preform between each sleeving, fusing, and stretching.

20. The method of claim 12, further comprising coating the cane waveguide after the sleeving, fusing, and stretching.

21. The method of claim 12, wherein at least the repeated fusing and stretching involve a banded tractor pulling mechanism having an adjustable grip adapted to grip the stretched preform having a diameter between 2 mm and 10 mm.

22. A method of producing, in a drawing apparatus, an optical cane waveguide having a cladding, comprising:
placing a seed preform into a first tube to provide a first sleeved preform;
fusing and stretching the first sleeved preform in the drawing apparatus to provide a stretched preform;
placing at least a portion of the stretched preform into a second tube to provide a second sleeved preform, wherein at least one of the first or the second tube comprises silica; and
fusing and stretching the second sleeved preform to provide the cane waveguide in the drawing apparatus, wherein the cane waveguide has an outer diameter greater than 1 millimeter and a core diameter between 4 and 60 micrometers.

23. The method of claim 22, wherein the stretching of the first or the second sleeved preform involves a banded tractor pulling mechanism adapted to grip preform diameters ranging from hundreds of micrometers to 10 mm.
